(19) United States
(12) Patent Application Publication
(10) Pub. No.: US 2017/0083082 A1
(43) Pub. Date: Mar. 23, 2017

(54) IMAGE PROCESSING VIRTUAL REALITY CONTROLLER SYSTEM AND METHOD

(71) Applicants: Xiran Wang, Houston, TX (US); Kevin Hwading Chu, Houston, TX (US); Yangyang Chen, Houston, TX (US)

(72) Inventors: Xiran Wang, Houston, TX (US); Kevin Hwading Chu, Houston, TX (US); Yangyang Chen, Houston, TX (US)

(73) Assignee: Intellectual Fortress, LLC, Houston, TX (US)

(21) Appl. No.: 14/858,310

(22) Filed: Sep. 18, 2015

(51) Int. Cl. G06F 3/01; G06F 3/042

(52) U.S. Cl. CPC G06F 3/011; G06F 3/0425

(57) ABSTRACT

A virtual reality controller system including a virtual reality hardware and a responding device. The virtual reality hardware includes a processor, a first communication module, a sensor module, and an output module. The responding device includes a second communication module and is configured to communicate with the first communication module. The processor is configured to generate and display a virtual controller using the output module. The virtual controller is configured to control the responding device.

### RESERVATION OF COPYRIGHTS

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

One or more embodiments of the invention are directed to a virtual reality controller configured to interact with hardware components.

### SUMMARY

In general, in one aspect, one or more embodiments disclosed herein relate to a virtual reality controller system comprising: a virtual reality hardware comprising a processor, a first communication module, a sensor module, and an output module; and a responding device comprising a second communication module and configured to communicate with the first communication module, wherein, the processor is configured to generate and display a virtual controller using the output module, and wherein the virtual controller is configured to control the responding device.

In another aspect, one or more embodiments disclosed herein relate to a virtual reality controller system comprising: a virtual reality hardware comprising a processor, a first communication module, a sensor module, a virtualization module, and an output module; and a target hardware device, wherein the virtualization module is configured to receive a source file of the target hardware device, wherein the virtual reality device creates, using the source file, a virtual machine that emulates the target hardware device, and wherein an emulated target device controller is displayed using the output module.

Other aspects and advantages of the invention will be apparent from the following description and the appended claims.

### BRIEF DESCRIPTION OF DRAWINGS

FIG. 1 shows a virtual reality controller system according to one or more embodiments of the invention.

FIG. 2 shows a virtual reality controller method according to one or more embodiments of the invention.

FIG. 3 shows a virtual reality controller method according to one or more embodiments of the invention.

FIG. 4 shows a virtual reality controller method according to one or more embodiments of the invention.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description, numerous specific details are set forth in order to provide a more thorough understanding of one or more embodiments of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create a particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a”, “an”, and “the” include plural referents unless the context clearly dictates otherwise. Thus, for example, reference to “a vehicle” includes reference to one or more of such vehicles. Further, it is to be understood that “or”, as used throughout this application, is an inclusive or, unless the context clearly dictates otherwise.

Terms like “approximately”, “substantially”, etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Embodiments of the invention generally relate to a virtual reality controller system. Embodiments of the invention generally relate to a method for using a virtual reality controller system to control a responding device. Embodiments of the invention generally relate to a non-transitory computer readable medium comprising computer readable program code.

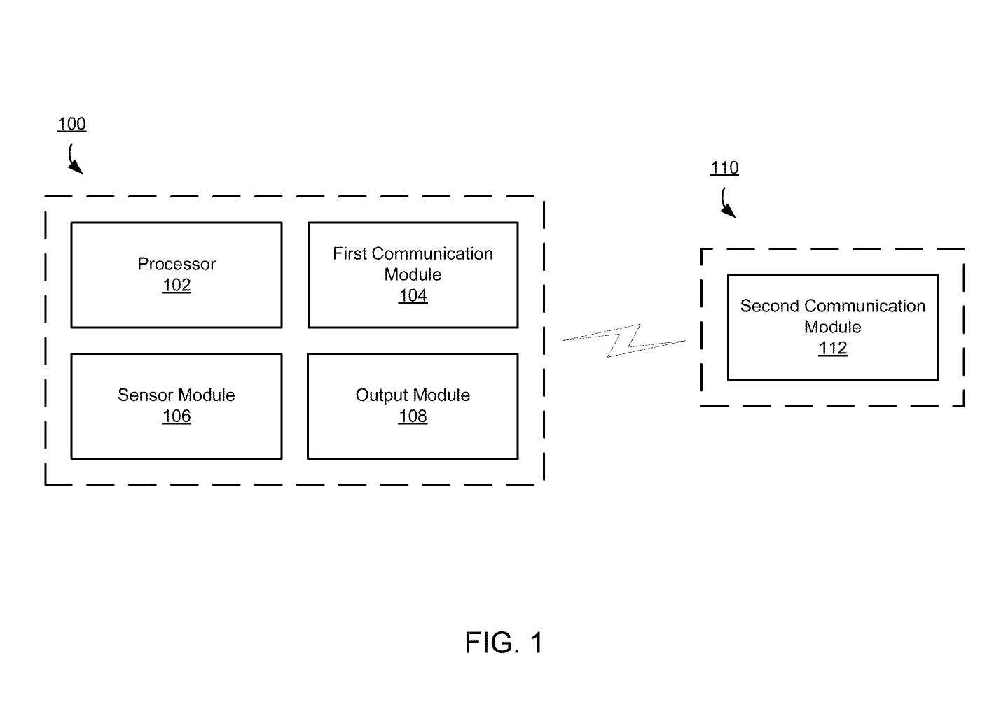

FIG. 1 shows a virtual reality controller system (100) according to one or more embodiments of the invention. As shown in FIG. 1, the system may comprise various components, including a processor (102), a first communication module (104), a sensor module (106), and an output module (108). Each of these components is described in more details below.

In one or more embodiments of the invention, the processor (102) may be an integrated circuit for processing instructions. For example, the processor (102) may be one or more cores, or micro-cores of a processor.

In one or more embodiments of the invention, the first communication module (104) may comprise an antenna and a receiver. The first communication module (104) may further comprise an encryption module configured to encrypt and decrypt and establish secure channel with various other hardware components.

In one or more embodiments of the invention, the sensor module (106) may include one or more sensors an infrared sensor, an accelerometer, a luminescence sensor, an image acquisition module (e.g., camera), etc.

In one or more embodiments of the invention, the output module (108) may be a cathode ray tube display (CRT), a light-emitting diode display (LED), an electroluminescent display (ELD), a plasma display panel (PDP), a liquid crystal display (LCD), an organic light-emitting diode (OLED), a laser color video display, an interferometric modulator display, head-up display (HUD), etc.

Embodiments of the virtual reality controller are wearable devices. The wearable devices may come in any form, shape, and size without departing from the spirit of the invention. For example, the wearable device may be a pair of glasses. For example, the wearable display may be a pair of goggles. Embodiments of the virtual reality controller are configured to control a plurality of hardware devices. Accordingly, one of ordinary skill in the art would appreciate that the specific interface of the virtual reality controller is not limited and may, for example, include an ON-OFF button, a volume dial, a button, and other input means. Further, the virtual reality controller may be a virtual mouse, a virtual keyboard, etc., configured to interact with a personal computer, a laptop, a tablet, a smartphone, etc.

The sensor module (106) is configured to detect signals including a user gesture, voice queue, etc., to create a virtual reality controller. The virtual reality controller, based upon the detected signals, may be configured to communicate with a second communication module (112) of a responding device (110). As with the first communication module (104), the second communication module (112) may also comprise an antenna and a receiver and an encryption module. The responding device (110) is not limited so long as it possesses a communication module that enables it (110) to communicate with the first communication module (104) of the virtual reality controller system (100). The responding device may, for example, be a vehicle, a computing device (e.g., a laptop, a desktop personal computer (PC), a smart phone, an electronic reader (e-reader), a tablet computer, etc.), a consumer electronic product (e.g., an air conditioning unit), an elevator, a prosthetic, an electronic door, or any electromechanical hardware device that may be capable of wired or wireless communication.

Turning to the flowcharts, while the various steps in the flowcharts are presented and described sequentially, one of ordinary skill will appreciate that some or all of the steps may be executed in different orders, may be combined or omitted, and some or all of the steps may be executed in parallel.

While the specification sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

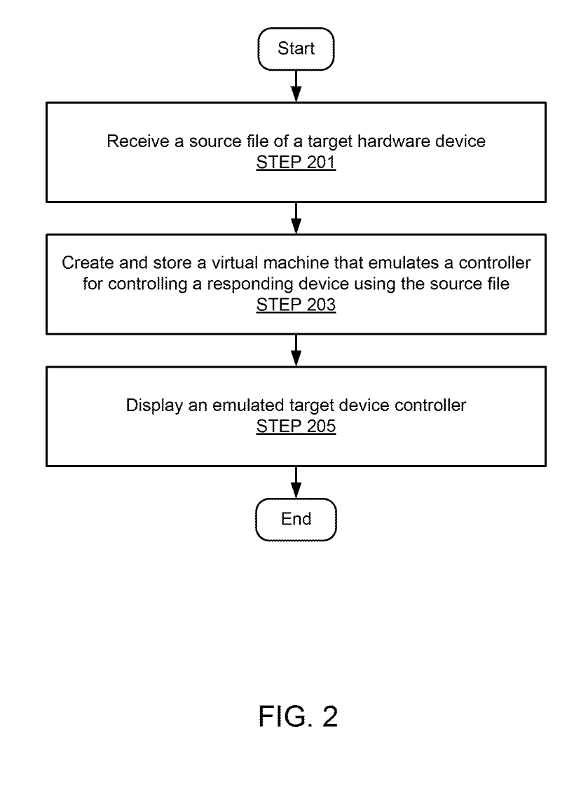

FIG. 2 shows a virtual reality controller method according to one or more embodiments of the invention. Specifically, FIG. 2 shows how the virtual reality controller system of FIG. 1 receives and creates a virtual reality controller that is configured to control a responding device.

In Step 201, a source file of a target hardware device (i.e., a responding device or a controller of the responding device) is obtained and stored by the virtual reality controller system. The transmission of the file may be completed either wired- or wirelessly. In one embodiment, the transmission may be initiated with the virtual reality controller system being within a range of detection of the target hardware device. In one embodiment, the source file may be transmitted upon the sensor module determining what the target hardware device is using image processing techniques. For example, the virtual reality controller system may, using a camera of the sensor module, determine presence of an air conditioning or a controller of the air conditioning. The camera may further identify the air conditioning to be of Model A of Brand B. Once the identification procedure is completed, the virtual reality controller may be configured to download the source file of a controller for controlling Brand B Model A's air conditioning. This is possible due to the individual defining visual, audio, etc., characteristics of many of today's electromechanical products. By comparing the imaged responding device to a library of products stored in a database (not shown) of the virtual reality controller system, it may be possible to identify the target hardware device, locate the requisite source file, and download the source file. In another embodiment, the camera may image the controller of the air conditioning and be able to identify and download the corresponding source file. One of ordinary skill in the art would appreciate that the means for downloading the source file is not limited. For example, the processor of virtual reality controller may crawl the internet.

In Step 203, a virtualization module of the virtual reality controller system creates and stores a virtual machine that emulates the target hardware device (in this case, a controller of an air conditioning) using the source file. Accordingly, the controller source file may include an instruction for increasing temperature, decreasing temperature, increasing fan speed, decreasing fan speed, changing direction of air blown, set timer, etc.

In Step 205, the display of the virtual reality controller system displays an emulated target device controller. Specifically, either by imaging the actual controller for controlling the air conditioning in Step 203 or by assigning the controller a default controller skin, an emulated target device controller (i.e., virtual reality controller) is displayed on the output module (108) of the virtual reality controller system.

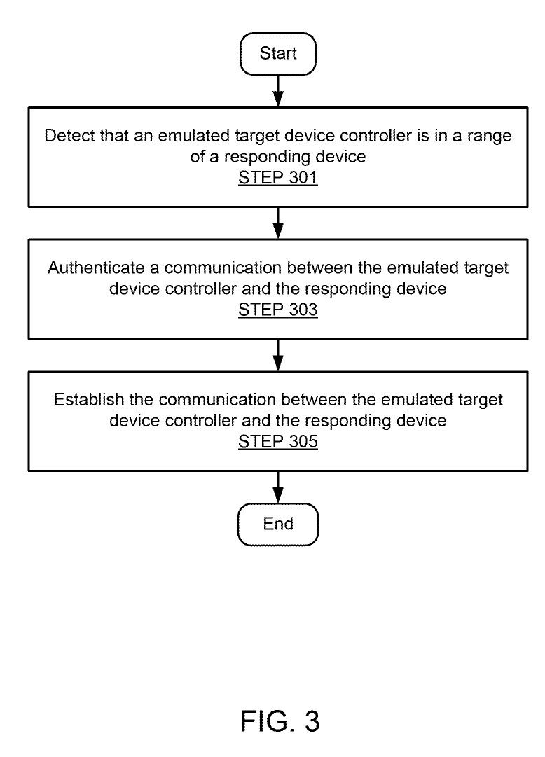

FIG. 3 shows a virtual reality controller method according to one or more embodiments of the invention. Specifically, FIG. 3 shows how a virtual reality controller may be configured to control a responding device.

In Step 301, a determination may be made by a processor of a virtual reality controller system regarding whether a responding device that is compatible with an emulated target device controller is in range. The means for detection are not limited and may be accomplished by sensors, wireless communication modules, etc.

Once the processor determines that the virtual reality controller system is within the range of the responding device, the flowchart proceeds to Step 303. In Step 303, the virtual reality controller system attempts to synchronize with the responding device. In so doing, the virtual reality controller system, using its associated wireless module, may establish a secured communication channel. And, upon completion of an authentication procedure (i.e., authentication of conventional password, biometrics, etc.), the flowchart may proceed to Step 305. One of ordinary skill in the art would appreciate that the responding device may be operatively connected to a database to enable the authentication procedure. That is, the responding device may be equipped with a database that stores a list of users capable of synchronizing/have permission to synchronize with the responding device. In embodiments where authentication is unnecessary, the database may or may not be omitted.

In Step 305, a wired or wireless communication is established between the virtual reality controller system and the responding device. Effectively, a wired or wireless communication is established between the emulated target device controller, which is stored in the virtual reality controller system, and the responding device.

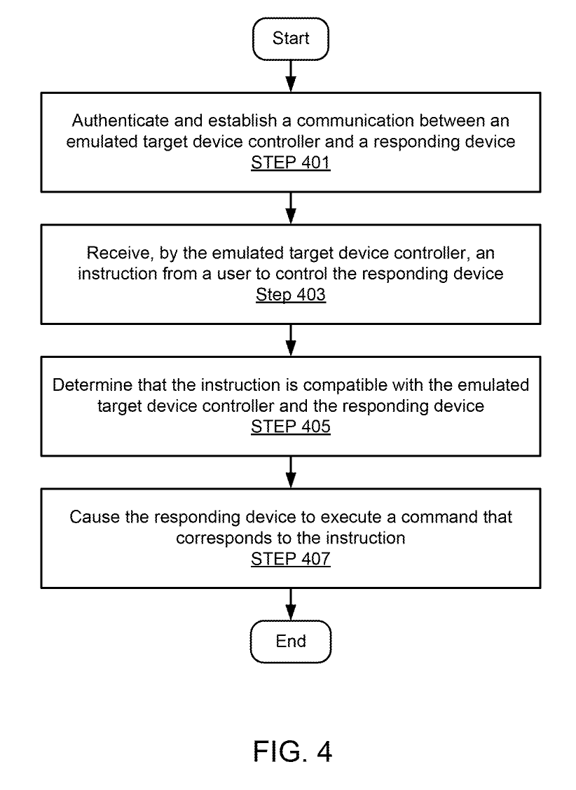

FIG. 4 shows a virtual reality controller method according to one or more embodiments of the invention. Specifically, FIG. 4 shows how the wired or wireless communication between the virtual reality controller system and the responding device enables control of the responding device by the emulated target device controller of the virtual reality controller system.

Step 401 is substantially similar to Step 303 and Step 305.

In Step 403, the emulated target device controller is configured to receive an instruction from a user that is configured to control the responding device. In one embodiment, the instruction may be in the form of a gesture. The sensor module of the virtual reality controller, upon detecting a gesture from a user and communicating with a database having a library of gestures that are mapped to specific instructions (which may be specific to the responding device), captures the gesture and enables the processor to decode and determine the instruction of the user. In the case that the responding device is an air conditioning, some of the stored gestures may correspond to increase temperature, decrease temperature, increase fan speed, decrease fan speed, change direction, etc. In the event that the same gesture may activate a plurality of instructions (e.g., pressing different buttons on the virtual reality controller), the virtual reality controller system is configured to determine the instruction of the user based on a coordinate system. Specifically, the sensor module is able to determine what is seen by the user via the output module of the virtual reality controller system. By mapping items located within to a coordinate system and determining where in the coordinate system the user is pressing, the virtual reality controller system is able to differentiate an attempt to increase temperature and an attempt to decrease temperature of an air conditioning. Said in another way, although the two functions may require similar gestures (e.g., clicking), the virtual reality controller system is capable of differentiating the two based upon the coordinate of the user's gesture. The coordinate system may be a three-dimensional coordinate system. However, the present invention is not limited thereto.

In Step 405, the processor, upon receiving the gesture data from the sensor module, determines whether the gesture is a legal gesture (i.e., whether the detected gesture is stored in the database of the responding device.). If it is determined that the gesture is not stored, nothing may happen. If it is determined that the gesture is not stored, the output module may be configured to inform the user that the gesture is invalid and prompt the user with hints of legal gestures.

If the gesture is determined to be legal, the flowchart may proceed to Step 407. In Step 407, the processor decodes the legal gesture and transmits the instruction to the responding device such that the responding device executes the instruction. For example, when the user gestures to increase temperature of the air conditioning and the sensor module and the processor decode the gesture to be a legal gesture that corresponds to increasing temperature of the air conditioning, the wireless module of the virtual reality controller system may, through the secure channel, wired- or wirelessly communicate with the air conditioning to increase the temperature of the air conditioning.

While the specification has been described with respect to one or more embodiments of the invention, those skilled in the art, having benefit of this disclosure, will appreciate that other embodiments can be devised which do not depart from the scope of the disclosure as disclosed herein.

For example, although the disclosure names a limited number of responding devices. One of ordinary skill in the art would appreciate that any electromechanical device that is capable of wired or wireless communication is able to interact with the virtual reality controller system according to one or more embodiments of the invention.

For example, although the disclosure indicates that a communication is established upon detection that the virtual reality controller system is within a range of the responding device and does not specify the range, one of ordinary skill in the art would appreciate that the range of detection is not limited and solely depends on the physical limitations of existing or to-be-developed wireless communication modules. Further, the nature of the communication is not limited and may be via internet, cellular network, etc.

For example, although the disclosure generally indicates the control of actuators (i.e., causing actuators to actuate), one of ordinary skill in the art would appreciate that this refers to causing any electromechanical hardware to function in accordance with their respective purposes (i.e., doors to open and close).

For example, although the disclosure indicates that the virtual reality controller is capable of controlling responding devices that are electromechanical hardware devices, the invention is not limited thereto. For example, the responding device may also be virtual. Accordingly, one or more embodiments are directed to generation and storage of controllers that control corresponding devices—the controllers and the corresponding devices may respectively be “virtual” or “reality”. An example of virtual-to-virtual interaction may be a user editing a virtual model, manipulating virtual components for architectural purposes, etc. An example of real-to-virtual interaction may be a user's facial expression being detected and then reflected as an avatar for an online game platform. Specifically, when the user is detected to be smiling by the sensor module, the in-game avatar may be smiling in the same/similar way. Similarly, caricatures or other representations that represent an individual virtually may be manipulated based on detection by the sensor module.

For example, although the disclosure appears to suggest that the correspondence between the controller and the responding device is 1-to-1, the invention is not limited thereto. Specifically, embodiments of the invention may be directed to a virtual reality control system and/or an emulated target device controller that is capable of controlling a plurality of responding devices. The plurality of responding devices may or may not be of the same type (i.e. the plurality of responding devices include five air conditionings or two air conditionings and a television remote controller.). Similarly, the responding device may be controller by a plurality of virtual reality control systems.

Advantageously, one or more embodiments of the invention enable individuals to operative machineries remotely, without being in proximity of dangerous environments. Embodiments of the invention have various applications and may be applied to industries including, for example, resource exploitation, space exploration, waste management, military, entertainment, etc.

For the purposes of this application, “reality” is defined as the natural unaltered state seen by an individual. For the purposes of this application, “virtual” is defined as anything that does not fall within the definition of “reality”. Thus, for example, “augmented reality”, which is typically defined as a live direct or indirect view of a physical, real-world environment whose elements are augmented by computer-generated sensory input, falls within the definition of “virtual”. However, it should be noted that, if the “augmented reality” is displayed on a hardware component, the hardware component itself falls within the definition of “reality”.

Furthermore, one of ordinary skill in the art would appreciate that certain “components”, “modules”, “units”, “parts”, “elements”, or “portions” of the one or more embodiments of the invention may be implemented by a circuit, processor, etc., using any known methods. Accordingly, the scope of the disclosure should be limited only by the attached claims.

What is claimed is:

1. A virtual reality controller system comprising:
a virtual reality hardware comprising a processor, a first communication module, a sensor module, and an output module; and
a responding device comprising a second communication module and configured to communicate with the first communication module,
wherein the processor is configured to generate and display a virtual controller using the output module, and
wherein the virtual controller is configured to control the responding device.

2. The system according to claim 1, wherein the virtual controller is generated upon the sensor module detecting a presence of the responding device or the first communication module being in a range of the responding device.

3. The system according to claim 1, wherein:
the sensor module comprises at least one of a motion sensor and an image acquisition unit,
the output module is a flexible display,
the motion sensor is configured to detect a motion, an orientation, and a location of a user using the virtual reality hardware, and
the image acquisition unit is a camera.

4. The system according to claim 3, wherein, upon the sensor module detecting an instruction from the user that is compatible with the virtual controller and the responding device, the processor, using the first communication module, is configured to transmit the instruction to the second communication module and cause the responding device to execute a command that corresponds to the instruction.

5. The system according to claim 1, wherein:
the responding device is an actuator, and
upon the sensor module detecting an instruction from a user that is compatible with the virtual controller and the responding device, the processor, using the first communication module, is configured to transmit the instruction to the second communication module and cause the actuator to actuate according to a command that corresponds to the instruction.

6. The system according to claim 1, wherein the virtual controller is configured to control a plurality of responding devices.

7. The system according to claim 6, wherein two of the plurality of responding devices are an air conditioning and a television.

8. The system according to claim 1, wherein:
the virtual controller comprises a virtual mouse and a virtual keyboard, and
the responding device is one selected from the group consisting of: a personal computer, a laptop, a smartphone, and a tablet.

9. The system according to claim 1, wherein the responding device is a virtual responding device displayed using the output module.

10. The system according to claim 1, wherein the virtual controller controls the responding device only after an authentication process that authenticates a communication between the virtual reality controller system and the responding device.

11. The system according to claim 1, wherein the responding device is configured to respond to a plurality of virtual controllers.

12. The system according to claim 1, wherein the virtual controller is one selected from a group consisting of: an ON-OFF switch and a volume dial.

13. A virtual reality controller system comprising:
a virtual reality hardware comprising a processor, a first communication module, a sensor module, a virtualization module, and an output module; and
a target hardware device,
wherein the virtualization module is configured to receive a source file of the target hardware device,
wherein the virtual reality device creates, using the source file, a virtual machine that emulates the target hardware device, and
wherein an emulated target device controller is displayed using the output module.

14. The system according to claim 13, wherein the target hardware device is one selected from the group consisting of: a personal computer, a laptop, a smartphone, and a tablet.

15. The system according to claim 13, wherein the target hardware device is a prosthesis.

16. The system according to claim 13, wherein the emulated target device controller is configured to control a responding device.

17. The system according to claim 16, wherein the responding device is a virtual responding device displayed using the output module.

18. The system according to claim 16, wherein the responding device is at least one selected from a group consisting of: a vehicle and a prosthesis.

19. The system according to claim 16, wherein:
the responding device is at least one selected from a group consisting of: a personal computer, a laptop, a smartphone, and a tablet, and
the emulated target device controller includes at least one selected from a group consisting of: a virtual mouse and a virtual keyboard.

20. The system according to claim 16, wherein:
the responding device is an actuator having a second communication module, and
upon the sensor module detecting an instruction from a user that is compatible with the emulated target device controller and the responding device, the processor, using the first communication module, is configured to transmit the instruction to the second communication module and cause the actuator to actuate according to a command that corresponds to the instruction.
